(19) United States
(12) Patent Application Publication
(10) Pub. No.: US 2009/0272696 A1
(43) Pub. Date: Nov. 5, 2009

(54) FILTRATION AND DRAINAGE APPARATUSES AND METHODS

(76) Inventors: Tom Simon, Statesville, NC (US); Charles Earl Gunter, Mooresville, NC (US)

Correspondence Address: MOORE & VAN ALLEN PLLC, P.O. BOX 13706, Research Triangle Park, NC, 27709, US

(21) Appl. No.: 12/434,491

(22) Filed: May 1, 2009

Related U.S. Application Data
(60) Provisional application No. 61/049,640, filed on May 1, 2008.

(51) Int. Cl. B01D 35/31; C02F 1/50

(52) U.S. Cl. 210/747; 210/170.03

(57) ABSTRACT

Embodiments of the present invention generally relate to apparatuses and methods for collecting, filtering, and/or draining fluid from a surface. For example, according to one embodiment, an apparatus is structured for positioning at least partially below the surface, and the apparatus comprises: (1) a core comprising a base portion and a plurality of fingers extending therefrom; and (2) a filter media comprising a plurality of polymer fibers structured so that the filter media is capable of filtering particles as small as approximately fifty microns from fluid flowing through the filter media, and wherein the filter media is disposed at least partially around the core so that together the core and the filter media define a flow channel, the flow channel being structured to drain fluid away from the surface.

### CROSS-REFERENCE TO RELATED APPLICATION

This application claims priority from U.S. Provisional Application No. 61/049,640 filed May 1, 2008, entitled “Filtration and Drainage Systems and Methods” and which is hereby incorporated herein by reference.

### FIELD

Embodiments of the present invention relate generally to apparatuses and methods for collecting, filtering, and/or draining fluid from a surface.

### BACKGROUND

Drainage systems of various types, sizes, and shapes are desirable for a number of applications. For example, numerous surfaces, such as, for example, synthetic turf or natural grass surfaces (sometimes referred to herein as “turf-grass”), associated with football/soccer fields and golf courses require drainage systems to collect and direct rainwater and other fluids to underground storm sewers for treatment and run-off control, as well as to prevent flooding. Similarly, drainage systems are often used to collect and direct fluids away from structures, such as parking garages, bridge abutments, and residential homes. Roadways, driveways, runways, parking lots, and the like may also require drainage systems.

In some instances, fluid passing through the drainage system may contain harmful pollutants, such as hydrocarbons, heavy metals, phosphates, and phosphorus. For example, rainwater passing across a highway picks up sediments that contain hydrocarbons. Rainwater may also pickup copper, zinc, and other harmful metals commonly found in automobile parts, such as brake pads. Thus, typically (depending on the intensity) in the first fifteen minutes of a rainstorm, contaminated rainwater is flushed from roadways into drainage systems, which may route the rainwater to natural tributaries and public waterways. This is sometimes referred to as a “first flush”. Likewise, water runoff from golf courses and other sporting fields having turf-grass may pass via these drainage systems to natural tributaries and public waterways. Due to the large quantities of pesticides, fertilizers, and herbicides that are often used to maintain turf-grass, this water runoff typically contains pollutants, such as phosphates and nitrates. Additionally, single-cell microorganisms (e.g., E. coli from wastewater treatment plant overflow, bird droppings, and other animal fecal matter) may be contributing pollutants to the water runoff. Thus, there is a need for a filtration-and-drainage apparatus and method capable of filtering, extracting and retaining, and/or killing harmful pollutants and/or microorganisms in water runoff.

In addition, numerous laws and regulations have been enacted to minimize pollution to natural tributaries and public waterways caused by contaminated water from traditional drainage systems. For example, the Clean Water Act (CWA) requires use of Best Management Practices (BMP) to treat/filter water that is routed by these drainage systems into natural tributaries and public waterways. Thus, there is a need for a filtration-and-drainage apparatus and method, which in addition to collecting, filtering, and draining water, also utilizes BMP to comply with requirements set forth by the CWA.

### BRIEF SUMMARY OF SELECTED EMBODIMENTS OF THE PRESENT INVENTION

Embodiments of the present invention relate generally to apparatuses and methods for collecting, filtering, and/or draining fluid from a surface. For example, in one embodiment, an apparatus for collecting, filtering, and draining fluid from a surface is provided. In one embodiment, the apparatus is structured for positioning at least partially below the surface, and the apparatus comprises: (1) a core comprising a base portion and a plurality of fingers extending therefrom; and (2) a filter media comprising a plurality of polymer fibers structured so that the filter media is capable of filtering particles as small as approximately fifty microns from fluid flowing through the filter media. In another embodiment, the filter media is disposed at least partially around the core so that together the core and the filter media define a flow channel, the flow channel being structured to drain fluid away from the surface.

In another embodiment of the apparatus, the filter media is capable of extracting and retaining at least approximately ninety-five percent of hydrocarbons from fluid flowing through the filter media. In another embodiment, the filter media is capable of extracting and retaining at least approximately sixty-five percent of soluble and non-soluble heavy metals and at least approximately fifty percent of phosphates and phosphorus from fluid flowing through the filter media. In another embodiment, the filter media comprises an antimicrobial agent so that the filter media is capable of killing at least approximately ninety-nine percent of single-cell microorganisms in fluid flowing through the filter media. In still another embodiment, the filter media is structured so that fluid may flow through the filter media at a flow rate of approximately two hundred gallons of fluid per minute per square foot of filter media surface area.

In another embodiment of the apparatus, the plurality of polymer fibers of the filter media comprise recycled industrial waste polymer fibers that are spun-woven together. In another embodiment, at least a portion of the core is heat-fusion bonded to at least a portion of the filter media so that the core is positioned relative to the filter media. In still another embodiment, the filter media surrounds the core, and in another embodiment, at least a portion of the core comprises a permeable media structured so that fluid may flow through the core.

In another embodiment of the present invention, another apparatus for collecting, filtering, and draining fluids from a surface is provided. In one embodiment, the apparatus is structured for positioning at least partially below the surface, and the apparatus comprises: (1) a filter media comprising a plurality of polymer fibers that are spun-woven together, the filter media structured to define a flow channel, the flow channel structured to drain fluid away from the surface; and (2) a core disposed at least partially within the flow channel, the core comprising a base portion and a plurality of fingers extending therefrom, the plurality of fingers structured to support at least a portion of the filter media away from the core.

In one embodiment of the apparatus, the filter media is capable of extracting and retaining at least approximately ninety-five percent of hydrocarbons and at least approximately sixty-five percent of soluble and non-soluble heavy metals from fluid flowing through the filter media. In another embodiment, the filter media is capable of extracting and retaining at least approximately fifty percent of phosphates and phosphorus from fluid flowing through the filter media. In another embodiment, the filter media further comprises an antimicrobial agent so that the filter media is capable of killing at least approximately ninety-nine percent of single-cell microorganisms in fluid flowing through the filter media.

In one embodiment of the apparatus, the filter media is capable of filtering particles as small as approximately fifty microns from fluid flowing through the filter media. In another embodiment, the filter media is structured so that fluid may flow through the filter media at a flow rate of approximately two hundred gallons of fluid per minute per square foot of filter media surface area. In still another embodiment, at least a portion of the core is heat-fusion bonded to at least a portion of the filter media so that the core is positioned relative to the filter media. In yet another embodiment, the filter media substantially surrounds the core, and the core comprises a lattice sheet structured so that fluid may flow through the lattice sheet, the plurality of fingers extending from the lattice sheet.

In one embodiment, a method for filtering and draining fluids from a surface is provided. In one embodiment, the method comprises: (1) providing an apparatus for filtering and draining fluid from a surface; (2) positioning the apparatus at least partially below the surface; (3) filtering fluid flowing through the filter media of the apparatus and into the flow channel of the apparatus; and (4) draining fluid collected in the flow channel of the apparatus away from the surface.

In one embodiment of the method, the apparatus comprises: (1) a core comprising a base portion and a plurality of fingers extending therefrom; and (2) a filter media comprising a plurality of polymer fibers that are spun-woven together, the filter media being disposed at least partially around the core so that together the core and the filter media define a flow channel, the flow channel being structured to drain fluid away from the surface. In another embodiment of the method, the filter media comprises an antimicrobial agent so that the filter media is capable of killing at least approximately ninety-nine percent of single-cell microorganisms in fluid flowing through the filter media. In another embodiment, the filter media is further capable of extracting and retaining at least approximately ninety-five percent of hydrocarbons, at least approximately sixty-five percent of soluble and non-soluble heavy metals, and at least approximately fifty percent of phosphates and phosphorus from fluid flowing through the filter media. In still another embodiment of the method, the filter media is capable of filtering particles as small as approximately fifty microns from fluid flowing through the filter media.

### BRIEF DESCRIPTION OF THE SEVERAL VIEWS OF THE DRAWINGS

Having thus described embodiments of the present invention in general terms, reference will now be made to the accompanying drawings, which are not necessarily draw to scale, and wherein:

FIG. 1 illustrates a perspective view of a filtration-and-drainage apparatus positioned below a turf-grass athletic field, in accordance with an embodiment of the present invention;

FIG. 2 illustrates a perspective view of a section of the filtration-and-drainage apparatus of FIG. 1, in accordance with an embodiment of the present invention;

FIG. 3 illustrates a cross-section view of the filtration-and-drainage apparatus of FIG. 1, in accordance with an embodiment of the present invention;

FIG. 4 illustrates a perspective view of a lattice core of a filtration-and-drainage apparatus, in accordance with an embodiment of the present invention; and

FIG. 5 illustrates a general process flow of a filtration-and-drainage apparatus, in accordance with an embodiment of the present invention.

### DETAILED DESCRIPTION OF EMBODIMENTS OF THE PRESENT INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa unless explicitly stated otherwise. Also, as used herein, the term “a” and/or “an” shall mean “one or more,” even though the phrase “one or more” is also used herein. Like numbers refer to like elements throughout.

In general terms, embodiments of the present invention address the need for an apparatus and method to filter rainwater and to drain the filtered rainwater away from paved or unpaved surfaces such as roadways, parking lots, air side and land side ports, airport pavements, vegetative swales, grass and turf grass applications common in green areas such as but not limited to sport fields. Although this description mainly refers to using embodiments of the invention in conjunction with rainwater and turf-grass surfaces, it should be appreciated that these embodiments may be used to filter and drain other types of fluids away from other types of surfaces or structures.

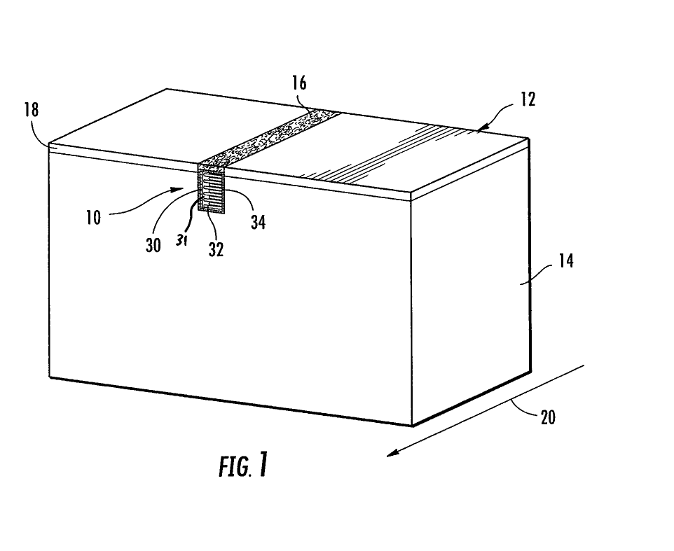

Referring now to FIG. 1, a perspective front view of a filtration-and-drainage apparatus 10 is illustrated according to one embodiment of the present invention. In this embodiment, the filtration-and-drainage apparatus 10 is positioned below a turf-grass athletic field 12 to filter contaminates and pollutants from rainwater and then to drain the filtered rainwater away from the field 12. In the illustrated embodiment, the filtration-and-drainage apparatus 10 is buried in a subsoil foundation 14 beneath a layer of aggregate 16, which is positioned adjacent a turf-grass surface 18. The aggregate 16 may be fine, course, and/or a blended mixture of fine and course materials. In one embodiment, the aggregate 16 comprises sand.

It will be understood that rainwater not absorbed by the turf-grass surface 18 may migrate from the turf-grass surface 18 to the aggregate 16, and then seep down through the aggregate 16 to the filtration-and-drainage apparatus 10. Additionally, rainwater not absorbed by the subsoil 14, may migrate from the subsoil 14 to the filtration-and-drainage apparatus 10. The filtration-and-drainage apparatus 10 filters contaminates and pollutants from the rainwater and then drains the filtered/treated rainwater away from the field 12 in the direction indicated by axis 20.

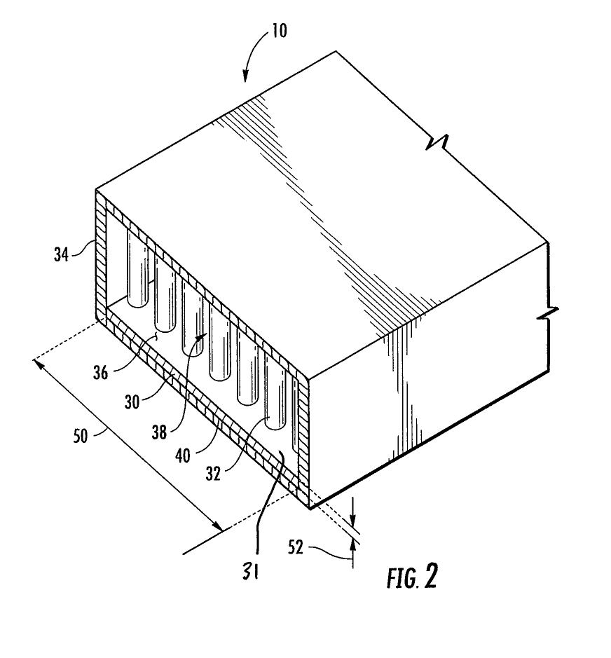

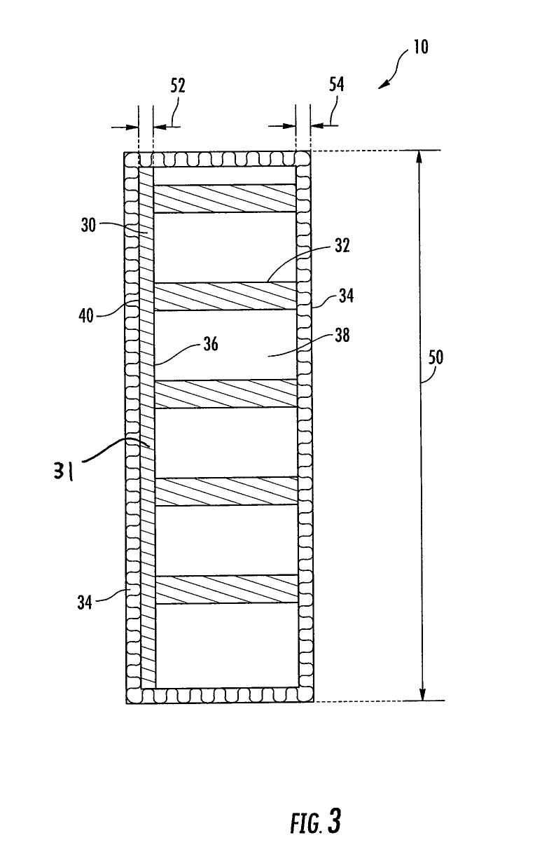

FIGS. 2 and 3 provide more detailed views of the filtration-and-drainage apparatus 10 illustrated in FIG. 1, in accordance with an embodiment of the present invention. Specifically, FIG. 2 is a perspective view of a section of the filtration-and-drainage apparatus 10 of FIG. 1, and FIG. 3 illustrates a cross-section view of a section of the filtration-and-drainage apparatus 10 of FIG. 1.

As shown in FIGS. 1-3, according to one embodiment of the present invention, the filtration-and-drainage apparatus 10 comprises a filter media 34 and a core 30 comprising a base portion 31 and a plurality of fingers 32 extending therefrom. In one embodiment, as shown, the filter media 34 surrounds the core 30 so that together the filter media 34 and the core 30 define a flow channel 38 for collecting and draining filtered fluid away from the field 12.

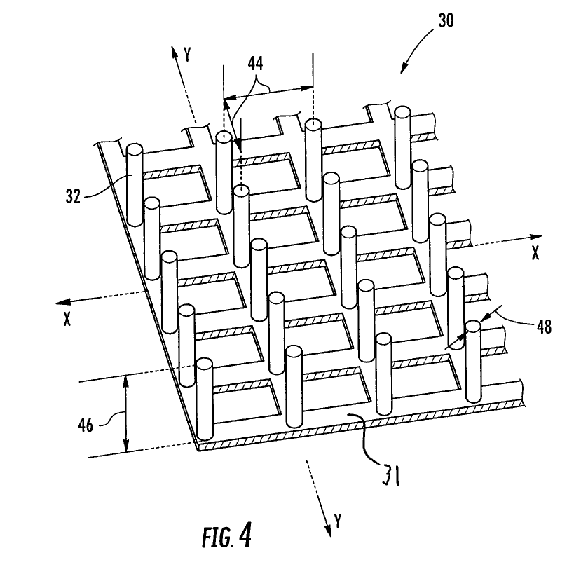

In one embodiment, the core 30 comprises a flat sheet of high-density polyethylene. In another embodiment, the core 30 comprises a height 50 of approximately five and one-half inches and a width 52 of approximately one-eighth of an inch. Of course, it will be understood that the core 30 may be constructed from a variety of materials. For example, according to one embodiment, the core 30 may be constructed from polymeric materials that are resistant to chemicals used to maintain turf-grass. In another embodiment, the core 30 may be constructed of materials so that the core 30 comprises a compressive strength capable of withstanding static forces that result from burial in a subsoil foundation. It will also be understood that the core 30 also may be structured in a variety of configurations. For example, the core 30 illustrated in FIG. 3 is solid and impermeable, whereas in other embodiments, such as the embodiment illustrated in FIG. 4, the core 30 is of a lattice construction. The lattice core 30 of FIG. 4, in comparison to the solid core of FIG. 3, is permeable, lighter in weight, and more flexible, and, in operation, the lattice core 30 increases the water-intake rate of the filtration-and-drainage apparatus 10. In other embodiments, portions of the core 30 may be solid and impermeable and other portions may be of a lattice construction.

As shown in FIGS. 1-4, according to one embodiment, the fingers 32 are substantially rigid and perpendicularly extend from a first side 36 of the base portion 31 of the core 30. In some embodiments, the fingers 32 are structured to support one or more portions of the filter media 34 away from one or more portions of the core 30. In another embodiment, fingers 32 are structured to prevent the filter media 34 from collapsing against the core 30. In still another embodiment, the fingers 32 are structured to provide a rectangular transverse cross-section that functions as a flow channel 38 through which fluid may collect and/or drain. With reference to the exemplary fingers 32 of FIG. 4, the distance 44 between the centers of the fingers 32 is approximately one and three-eighths of an inch. This distance 44 between each of the fingers 32 provides a filtration-and-drainage apparatus 10 that may bend without the filter media 34 collapsing into the flow channel 38. For example, as shown in FIG. 4, the filtration-and-drainage apparatus 10 may bend about axis X-X and about an axis Y-Y. This distance 44 also provides the core 30 with an optimum amount of cross-sectional area for fluid flow with a small amount of resistance from the fingers 32. In one embodiment, the fingers 32 have a length 46 of approximately seven-eighths of an inch and a diameter 48 of approximately two-eighths of an inch.

In one embodiment, the filter media 34 is heat-fusion bonded to the second side 40 of the base portion 31 of the core 30. Similarly, in another embodiment, the filter media 34 is heat-fusion bonded to the ends 42 of each finger 32. This bonding prevents the filter media 34 from moving relative to the core 30, thereby preventing the filter media 34 from collapsing around the fingers 32 and obstructing the flow channel 38. In other embodiments, fasteners or adhesives may be used to attach the filter media 34 to the base portion 31 and/or the fingers 32 of the core 30. In other embodiments, the filter media 34 may be form-fitted to the core 30 and/or fastened, glued, and/or otherwise bonded to the fingers 32.

Referring now to FIG. 4, according to an embodiment of the present invention, a lattice core 30 is provided. In this embodiment, the filter media 34 of FIGS. 1-3 wraps around the entire core 30, thereby preventing unfiltered water from entering the flow channel 38. However, in other embodiments, the filter media 34 may be disposed only partially around the core 30. For example, in one embodiment, the filter media 34 may extend all the way around the core 30 except for the second side 40 of the base portion 31 of the core 30. It will also be understood that, in other embodiments, the filter media 34 may comprise two or more layers, as needed, for filtering fluid that flows through the filter media 34. In other words, fluid may first flow through a first filtering layer (not shown) of the filter media 34, then flow through a second filtering layer (not shown) of the filter media 34, etc., before the fluid is collected in the flow channel 38.

In some embodiments, the filter media 34 is constructed of recycled industrial waste polymer fibers that are spun-woven into sheets and/or fabric “blankets”. Industrial waste may comprise natural and/or synthetic fibers, fabrics, and/or foams that may be prepared by grinding, steaming, and/or, in some cases, chemical washing. In some embodiments, the fibers are then spun-woven and/or molded into a sheet or fabric blanket. Sources of industrial waste may include, for example, sofas, chairs, mattresses, carpet, automotive interiors, textiles, and/or clothing. However, it will be understood that, in other embodiments, the filter media 34 may comprise other types of polymer fibers and/or be of a different woven or non-woven manufacture.

In one embodiment, the filter media 34 may be formed by using individual fibers that are loose-bonded together to form vast interstitial spaces capable of trapping very fine particles. For example, according to one embodiment, the filter media 34 is capable of filtering particles as small as fifty microns from the fluid that flows through the filter media 34. In some embodiments, the filter media 34 may be additionally or alternatively structured so that fluid may flow through the filter media 34 at a flow rate of approximately two hundred gallons of fluid per minute per square foot of filter media surface area. In some embodiments, the filter media 34 additionally or alternatively may be capable of extracting and retaining approximately ninety-five percent of hydrocarbons, sixty-five percent of soluble and non-soluble heavy metals, and/or at least fifty percent of phosphates and phosphorus. Moreover, in some embodiments, the filter media 34 may be treated with an antimicrobial agent that kills over ninety-nine percent of single-cell microorganisms from the fluid that flows through the filter media 34, including, for example, enterococcus, Escherichia coli, fecal coliforms, Aspergillus niger, Trychophton mentagrophytes, Penicillium pinophilum, Chaetomium globosum, and/or other bacteria, viruses, and/or algae. Thus, once rainwater passes through and is filtered by the filter media 34, the treated rainwater is safe to route to natural tributaries and public waterways.

It will be understood that the filter media 34 may be constructed in various shapes and sizes. For example, in one embodiment, the filter media 34 is a twelve ounce, three-eighths inch thick fabric blanket that is able to absorb up to twenty-seven times its own molecular weight in hydrocarbons. As another example, as shown in FIG. 3, the filter media 34 comprises a thickness 54 of approximately an eighth of an inch, a width sufficient to surround the core 30, and a length that runs the entire length of the filtration-and-drainage apparatus 10.

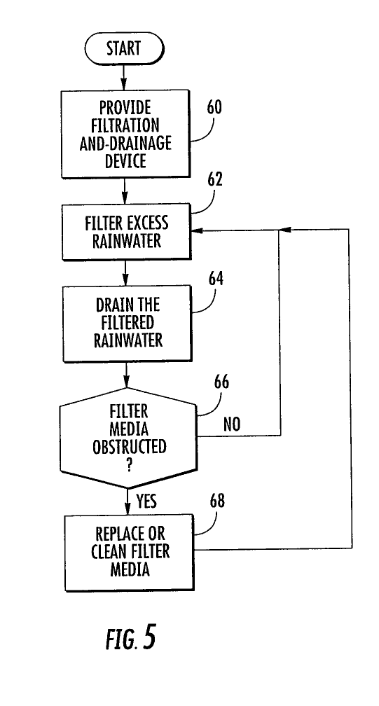

Referring now to FIG. 5, a method is provided for filtering and draining excess rainwater from a turf-grass surface 18 without contaminating public waterways. As represented by the block 60, the filtration-and-drainage apparatus 10 of FIG. 1 is buried in the subsoil layer 14, underneath the turf-grass surface 18, in a manner such that excess rainwater migrates along the surface 18 and towards the filtration-and-drainage apparatus 10. It will also be understood that excess water may also migrate through the subsoil layer 14 and towards the filtration-and-drainage apparatus 10. As represented by the block 62, the excess rainwater is filtered as it passes through the filter media 34 and into the flow channel 38. In addition to preventing particulate matter from entering, and thereby obstructing, the flow channel 38, it will be understood that the block 62 also represents extracting and retaining hydrocarbons from the rainwater and/or killing microorganisms in the rainwater. As represented by the block 64, the treated rainwater is drained/routed away from the field 12. Because the rainwater is treated according to BMP and in compliance with the CWA, the treated rainwater may be drained/routed toward a public waterway or reservoir.

As represented by the block 66, a determination is made regarding the level of obstruction of the filter media 34. Because flow-rate through the filter media 34 is proportional to the level of obstruction, the level of obstruction may be approximated by monitoring the flow-rate through the filter media 34 relative to the amount of excess rainwater on the turf-grass surface 18 and/or the saturation level of the subsoil layer 14. In some embodiments, the flow rate through the filter media 34 is approximately equal to the flow-rate through the flow channel 38. Accordingly, for example, if excess rainwater exists on the turf-grass surface 18 and/or the subsoil layer 14 is saturated with rainwater, but the flow rate through the flow channel 38 is relatively low, then the flow rate through the filter media 34 is likely low as well. If so, this indicates an unacceptably high level of obstruction. On the other hand, if excess water exists on the turf-grass surface 18 and/or the subsoil layer 14 is saturated with rainwater, and the flow rate through the flow channel 38 is relatively high, then level of obstruction is likely acceptable. In other embodiments, a determination is made about the level of obstruction based on the amount of time that the filter media 34 has been in use and/or past experience as to how long the filter media 34 can be used in the same or similar application.

As shown in FIG. 5, if the level of obstruction is acceptable, then the method, as represented by the blocks 62, 64, and 66, is repeated. However, if the level of obstruction is unacceptably high, then the filter media 34 is either replaced or cleaned, as represented by the block 68. It should be appreciated that embodiments of the above-described method may be used to capture and completely remove contaminants and/or pollutants from the environment.

Specific embodiments of the invention are described herein. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. An apparatus for collecting, filtering, and draining fluid from a surface, the apparatus structured for positioning at least partially below the surface, the apparatus comprising:
a core comprising a base portion and a plurality of fingers extending therefrom; and
a filter media comprising a plurality of polymer fibers structured so that said filter media is capable of filtering particles as small as approximately fifty microns from fluid flowing through said filter media; and
wherein said filter media is disposed at least partially around said core so that together said core and said filter media define a flow channel, said flow channel being structured to drain fluid away from the surface.

2. The apparatus of claim 1, wherein said filter media is capable of extracting and retaining at least approximately ninety-five percent of hydrocarbons from fluid flowing through said filter media.

3. The apparatus of claim 1, wherein said filter media is capable of extracting and retaining at least approximately sixty-five percent of soluble and non-soluble heavy metals and at least approximately fifty percent of phosphates and phosphorus from fluid flowing through said filter media.

4. The apparatus of claim 1, wherein said filter media comprises an antimicrobial agent so that said filter media is capable of killing at least approximately ninety-nine percent of single-cell microorganisms in fluid flowing through said filter media.

5. The apparatus of claim 1, wherein said filter media is structured so that fluid may flow through said filter media at a flow rate of approximately two hundred gallons of fluid per minute per square foot of filter media surface area.

6. The apparatus of claim 1, wherein said plurality of polymer fibers of said filter media comprise recycled industrial waste polymer fibers that are spun-woven together.

7. The apparatus of claim 1, wherein at least a portion of said core is heat-fusion bonded to at least a portion of said filter media so that said core is positioned relative to said filter media.

8. The apparatus of claim 1, wherein said filter media surrounds said core.

9. The apparatus of claim 8, wherein at least a portion of said core comprises a permeable media structured so that fluid may flow through said core.

10. An apparatus for collecting, filtering, and draining fluids from a surface, the apparatus structured for positioning at least partially below the surface, the apparatus comprising:
a filter media comprising a plurality of polymer fibers that are spun-woven together, said filter media structured to define a flow channel, said flow channel structured to drain fluid away from the surface; and
a core disposed at least partially within said flow channel, said core comprising a base portion and a plurality of fingers extending therefrom, said plurality of fingers structured to support at least a portion of said filter media away from said core.

11. The apparatus of claim 10, wherein said filter media is capable of extracting and retaining at least approximately ninety-five percent of hydrocarbons and at least approximately sixty-five percent of soluble and non-soluble heavy metals from fluid flowing through said filter media.

12. The apparatus of claim 10, wherein said filter media is capable of extracting and retaining at least approximately fifty percent of phosphates and phosphorus from fluid flowing through said filter media.

13. The apparatus of claim 10, wherein said filter media further comprises an antimicrobial agent so that said filter media is capable of killing at least approximately ninety-nine percent of single-cell microorganisms in fluid flowing through said filter media.

14. The apparatus of claim 10, wherein said filter media is capable of filtering particles as small as approximately fifty microns from fluid flowing through said filter media.

15. The apparatus of claim 10, wherein said filter media is structured so that fluid may flow through said filter media at a flow rate of approximately two hundred gallons of fluid per minute per square foot of filter media surface area.

16. The apparatus of claim 10, wherein at least a portion of said core is heat-fusion bonded to at least a portion of said filter media so that said core is positioned relative to said filter media.

17. The apparatus of claim 1, wherein said filter media substantially surrounds said core, and wherein said core comprises a lattice sheet structured so that fluid may flow through said lattice sheet, said plurality of fingers extending from said lattice sheet.

18. A method for filtering and draining fluids from a surface, the method comprising:
providing an apparatus for filtering and draining fluid from a surface, the apparatus comprising:
a core comprising a base portion and a plurality of fingers extending therefrom; and
a filter media comprising a plurality of polymer fibers that are spun-woven together, the filter media being disposed at least partially around the core so that together the core and the filter media define a flow channel, the flow channel being structured to drain fluid away from the surface;
positioning the apparatus at least partially below the surface;
filtering fluid flowing through the filter media of the apparatus and into the flow channel of the apparatus; and
draining fluid collected in the flow channel of the apparatus from the surface.

19. The method of claim 18, wherein the filter media comprises an antimicrobial agent so that the filter media is capable of killing at least approximately ninety-nine percent of single-cell microorganisms in fluid flowing through the filter media, and wherein the filter media is further capable of extracting and retaining at least approximately ninety-five percent of hydrocarbons, at least approximately sixty-five percent of soluble and non-soluble heavy metals, and at least approximately fifty percent of phosphates and phosphorus from fluid flowing through the filter media.

20. The method of claim 18, wherein the filter media is capable of filtering particles as small as approximately fifty microns from fluid flowing through the filter media.
